(19) United States
(12) Patent Application Publication
(10) Pub. No.: US 2007/0267046 A1
(43) Pub. Date: Nov. 22, 2007

(54) Cleaning Process For Removing Magnetite-Containing Deposits From A Pressure Vessel Of A Power Station

(75) Inventors: Konrad Bitter, Herzogenaurach (DE); Johann Hluchy, Heroldsbach (DE)

Correspondence Address: LERNER GREENBERG STEMER LLP, P O BOX 2480, HOLLYWOOD, FL, 33022-2480, US

(73) Assignee: Areva NP GmbH

(21) Appl. No.: 11/667,619

(22) PCT Filed: Oct. 25, 2005
(86) PCT No.: PCT/EP05/11409

§ 371 Date: Jul. 30, 2007

(30) Foreign Application Priority Data
Nov. 11, 2004 (DE) 10 2004 054 471.9

(51) Int. Cl. B08B 3/00

(52) U.S. Cl. 134/29; 134/26

(57) ABSTRACT

A cleaning method for removing deposits containing magnetite out of a pressure vessel of a power plant, during which the deposits are treated with an aqueous cleaning solution, which contains a reducing agent and which is heated to an elevated cleaning temperature above ambient temperature, in order to reduce iron III ions to iron II ions. The cleaning solution is introduced into the pressure vessel. This cleaning solution contains an initial substance that releases the reducing agent under the conditions existing during cleaning. Hexamethylenetetramine is preferably used as the initial substance.

The invention relates to a cleaning process for removing magnetite-containing deposits from a pressure vessel of a power station. Such a process is known, for example, from EP 273 182 A1. For the purposes of the present invention, pressure vessels are, for example, boilers of conventional power stations or the secondary side of steam generators in nuclear power stations. In pressure vessels comprising industrial-grade steel, magnetite deposits in the form of a solid layer on the interior surface of the vessel, on the surface of the heating tube and mainly in the form of loose collections of sludge which settle at the bottom of the vessels or in regions in which flow is reduced. Magnetite can be considered to be a mixture of iron(II) oxide and iron(III) oxide. The use of complexing agents such as EDTA at elevated cleaning temperatures for removing the deposits is known. To convert the iron(III) into the more readily complexable iron(II), hydrazine is generally used as reducing agent. The handling of hydrazine is problematical because this substance is not without toxicological concerns. Thus, a carcinogenic action, for example, has been found for this substance. The handling of hydrazine therefore requires a high outlay for measures which prevent escape of hydrazine into the surroundings. The legal consequences of a “hydrazine accident” involving harm to personnel would have to be examined with future problems which could arise as a result of contamination and incorporation being taken into account before each use.

It is therefore an object of the invention to propose a cleaning process of the type mentioned at the outset by means of which the disadvantages indicated can be circumvented.

This object is achieved in a cleaning process as claimed in claim 1 by introducing a cleaning solution containing a presubstance which liberates the reducing agent under the conditions prevailing during cleaning, for instance at elevated temperature and/or in a slightly acidic pH range, into the pressure vessel. This makes it possible to use a presubstance which is toxicologically acceptable or at least less harmful than hydrazine, so that the risk of damage to the health of personnel and pollution of the environment is reduced during delivery and during feeding of the cleaning solution into a pressure vessel.

Furthermore, the process of the invention is carried out in two stages, with a treatment with a first cleaning solution I containing the presubstance being carried out in a first stage, namely a reduction stage, and a second cleaning solution II containing a complexing agent which forms a soluble complex with divalent iron ions being fed into the pressure vessel in a subsequent second stage, viz. a complexation stage. The two-stage procedure is based on the following considerations: the reduction of magnetite takes considerably longer than the complexation of iron(II), which is attributable, inter alia, to it being associated with a destruction of the magnetite lattice. If relatively high concentrations of complexing agents were to be present during the reduction phase, these could, particularly if the process is carried out in acidic solution, considerably accelerate oxidative attack on the metal of construction as a result of them removing iron(II) going over into the solution from the redox equilibrium by complex formation. In the process proposed, the solution containing the reducing agent can act on the magnetite deposits, for instance until they have been completely reduced, without an appreciable removal of metal of construction having to be feared. If a cleaning solution II containing the complexing agent is fed into the pressure vessel after the reduction stage, attack on the metal of construction is reduced firstly by a very large amount of iron(II) being available as reaction partner for the complexing agent, so that dissolution of the metal of construction as a competing reaction is suppressed. Secondly, the complexation of iron(II) proceeds at a high reaction rate and consequently in a short time, so that oxidative attack on the metal of construction, which proceeds at a lower reaction rate, does not occur to an appreciable extent.

Preference is given to using a presubstance which liberates an aldehyde, in particular formaldehyde, as reducing agent. This substance or aldehydes in general are reducing agents which are suitable for reducing magnetite and are oxidized to carboxylic acids in the reduction of the magnetite. These carboxylic acids can, as indicated further below, be removed from the pressure vessel during cleaning or be made undamaging in another way and corrosive attack on the metal of construction can thus be prevented.

The reduction stage is preferably carried out in slightly acidic to neutral solution, in particular in a pH range from 5 to 7, preferably from 5.0 to 7.0. This measure takes account of the fact that the Pourbaix equilibrium line for the redox system Fe₃O₄/Fe(II) is at pH 6.8 (at room temperature). Maintenance of slightly acidic to neutral or at most slightly alkaline conditions ensures that the reduction of magnetite progresses at a sufficient reaction rate. Furthermore, preference is given to a complexing agent being added to the cleaning solution in an amount which corresponds to not more than 10% of the amount required for complexation of the amount of iron(II) formed by the reduction. This measure likewise shifts the abovementioned redox equilibrium to the side of iron(II) as a result of the complex binding the divalent iron ions and removing them from the equilibrium. Dissolution of the magnetite lattice is promoted in this way. EDTA is preferably used as complexing agent.

A very suitable presubstance for a cleaning process according to the invention is hexamethylenetetramine. This substance, also known under the name urotropin, is far less problematical than hydrazine in terms of toxicity, in particular at room temperature at which the cleaning solution I is delivered to a power station. Hexamethylenetetramine liberates formaldehyde in an acidic environment and in particular at elevated cleaning temperatures. Although formaldehyde is not a toxicologically unproblematical substance. The liberation occurs within the pressure vessel, i.e. in a closed system. Very good results, especially when using the substance pair hexamethylenetetramine/EDTA, are achieved in a temperature range from 90° C. to 200° C., preferably from 140° C. to 200° C. Lower temperatures, for instance from 90 to 120° C., are advantageous when temperature-sensitive corrosion inhibitors such as 1-octyn-3-ol are used for protection of the metal of construction. When a molar ratio of hexamethylene-tetramine to EDTA of from 3.5:1 to 2:1 is employed, rapid sludge dissolution is achieved and attack on the metal of construction is reduced to an insignificant level. The best results are achieved when the cleaning solution I contains from 0.6 to 0.7 mol/l of hexa-methylenetetramine and from 0.17 to 0.36 mol/l of EDTA. EDTA is also used as complexing agent in the second step, namely the complexing stage. In addition to EDTA being a very effective complexing agent which is available in large quantities at reasonable prices, there is the advantage that the reduction stage and the complexation stage are carried out using one and the same complexing agent, so that the total number of chemicals used and thus the risk of undesirable interactions between the chemicals is reduced.

The complexation stage is carried out in slightly acidic to slightly alkaline solution since particularly effective and thus rapid complexation is achieved in this pH range. A pH range of from 6 to 10, in particular from 6.5 to 9.3, is preferably maintained in the reaction solution. If not all the magnetite has been reduced in the reduction stage and accordingly a more or less large residual amount of magnetite is still present when the cleaning solution II is fed into the pressure vessel, the dissolution of the magnetite or the destruction of the magnetite lattice is accelerated by EDTA. However, the attack on the metal of construction is also accelerated, but is kept within limits firstly by the complexation reaction proceeding significantly more quickly than redox reactions in the metal-solution phase boundary region. Secondly, the pH is prevented from dropping to excessively low values which accelerate attack on the metal of construction by a further measure. This measure comprises adding triethylamine to the cleaning solution II. The amount is selected so that a slightly alkaline pH range is maintained. Triethylamine which effectively acts as buffer substance forms an adduct with the formic acid formed from the formaldehyde in the reduction of iron(III); the substance formed is volatile and vaporizes at the temperatures prevailing during the complexation stage and can thus be removed from the solution. Triethylamine equally reacts with CO₂ or with carbonic acid. This is formed when formaldehyde is oxidized through to the precursor carbon dioxide.

The addition of the alkaline triethylamine at the same time reduces the amount of alkalizing agents such as ammonia or morpholine, which is particularly advantageous in the case of the relatively expensive morpholine. Preference is given to using a reaction solution II which is saturated with EDTA at the respective cleaning temperature and contains a maximum of 0.5 mol/l of triethylamine.

### EXAMPLE

To carry out the process, part of the water present in the pressure vessel is drained so as to create room for the reaction solution to be fed in. The boiler water is then brought to the cleaning temperature, for example to 140° C., which can, for example, be effected by introducing steam. To feed in the reaction solutions I and II, it can be advantageous for these likewise to be brought to the cleaning temperature before being fed in.

The cleaning solutions I, II used for carrying out the two-stage cleaning process have the following composition:

| | | | | Amount |
|---|---|---|---|---|
| | | | | required for |
| | Hexa- | | | dissolution |
| | methylene- | Diammonium- | Tri- | of 1000 kg |
| | tetramine | EDTA | ethylamine | of magnetite |
| Cleaning | 0.713 | 0.356 | — | 1010 l |
| solution I | mol/l | mol/l | | |
| | | (=104 g/l) | | |
| Cleaning | — | 1.369 | max. 0.469 | 9210 l |
| solution II | | mol/l | mol/l | |
| | | (=400 g/l) | (=65 ml/l) | |

1010 l of reaction solution I, i.e. 0.713 kmol of hexa-methylenetetramine and 0.356 kmol of EDTA, are required for dissolving 1000 kg of magnetite in the reduction stage. In the complexation stage, 9210 l of cleaning solution II containing 1.369 kmol/l of EDTA and a maximum of 0.469 kmol/l of triethylamine are required. EDTA is soluble in water only in the form of its salts. For this reason, it is usual to use, for example, diammonium-EDTA or triammonium-EDTA or a mixture thereof, or trimorpholine-EDTA. In the cleaning solution II, up to 33% of the alkalizing agent NH₃ or morpholine can be saved by the addition of triethylamine.

The time for which the reduction stage is carried out depends first and foremost on the amount of magnetite to be reacted and ranges from about 15 minutes to a number of hours. To accelerate the reaction of magnetite, steam is vented from time to time. The depressurization results in intensive steam bubble formation and thus to strong turbulence and swirling-up of the sludge. The cleaning solution I fed into the pressure vessel is slightly acidic to neutral (pH from about 5 to 7), which is brought about by, for example, the EDTA which has partially reacted with ammonia or morpholine and acts as an acid. The presubstance hexa-methylenetetramine decomposes into formaldehyde and ammonia (reaction 1) at the prevailing cleaning temperature of about 140° C. Formaldehyde reduces the iron(III) of the magnetite to iron(II) and is itself oxidized to formic acid (reaction 2). At least part of the formic acid formed is neutralized by ammonia.

After a considerable part, most preferably the entire amount, of the magnetite has been reduced, which can, depending on the amount of magnetite to be removed and the cleaning temperature, take from about 20 minutes to a few hours, the cleaning solution II is, if appropriate after preheating, fed into the pressure vessel without the cleaning solution I present therein being drained beforehand. In the ideal case, i.e. when all the magnetite has been reduced, only the iron(II) is coordinated by EDTA and brought into solution in the complexation stage. The formic acid formed by oxidation of formaldehyde in the reduction stage or by reduction of residual magnetite in the complexation stage forms an adduct with triethylamine to give a volatile compound which at the prevailing temperatures goes over into the gas phase and can be removed from the pressure vessel by venting (reaction 3). The concentration or amount of triethylamine is selected so that the complexation proceeds in a slightly alkaline to neutral range, i.e. at a pH of from about 8.5 to 7. The formaldehyde liberated from hexamethylenetetramine can also be oxidized through to carbon dioxide (reaction 4). This or the carbonic acid formed therefrom likewise forms an adduct with triethylamine to give a volatile compound.
C₆H₁₂N₄+6H₂O→4NH₃+6 HCOH Reaction 1:
Fe₃O₄+HCOH→3 FeO+HCOOH Reaction 2:
(C₂H₅)₃N+HCOOH→[(C₂H₅)₃NH]⁺HCOO⁻ Reaction 3:
2 Fe₃O₄+HCOH→6 FeO+CO₂+H₂O Reaction 4:

1-19. (canceled)

21. A cleaning process for removing magnetite-containing deposits from a pressure vessel of a power station, the process comprising:
treating the deposits in a two-stage process, including:
a reduction stage, wherein the deposits in the pressure vessel are treated with a first cleaning solution I containing a presubstance configured to liberate a reducing agent under conditions prevailing during cleaning, and heated to an elevated cleaning temperature above room temperature, in order to reduce iron(III) ions to iron(II) ions; and
a subsequent complexation stage, wherein a second cleaning solution II is metered into the process, the second cleaning solution II containing triethylamine and a complexing agent configured to form a soluble complex with divalent iron ions.

22. The cleaning process according to claim 21, wherein the second cleaning solution II is saturated with EDTA and contains not more than 0.5 mol/l of triethylamine.

23. The cleaning process according to claim 21, which comprises employing a presubstance configured to liberate an aldehyde as the reducing agent.

24. The cleaning process according to claim 23, which comprises employing a presubstance configured to liberate formaldehyde as the reducing agent.

25. The cleaning process according to claim 21, which comprises carrying out the reduction stage in slightly acidic to slightly alkaline solution.

26. The cleaning process according to claim 25, which comprises maintaining a pH from substantially 5 to substantially 7 during the reduction stage.

27. The cleaning process according to claim 26, which comprises maintaining a pH from 5.0 to 7.0 in the reduction stage.

28. The cleaning process according to claim 21, which comprises adding a complexing agent to the first cleaning solution I in an amount corresponding to no more than 10% of an amount required for complexing an amount of iron(II) formed by the reduction.

29. The cleaning process according to claim 28, which comprises employing EDTA as the complexing agent.

30. The cleaning process according to claim 21, wherein the presubstance is hexamethylenetetramine.

31. The cleaning process according to claim 21, wherein the process is carried out at a temperature ranging from 90° C. to 200° C.

32. The cleaning process according to claim 31, wherein the process is carried out in a temperature range of from 140° C. to 200° C.

33. The cleaning process according to claim 30, which comprises employing a first cleaning solution I with hexamethylenetetramine and EDTA present in a molar ratio of from 3.5:1 to 2:1.

34. The cleaning process according to claim 33, wherein the first cleaning solution I contains from 0.6 to 0.7 mol/l of hexamethylenetetramine and from 0.17 to 0.36 mol/l of EDTA.

35. The cleaning process according to claim 21, which comprises employing a second cleaning solution II containing EDTA as a complexing agent.

36. The cleaning process according to claim 35, which comprises employing a second cleaning solution II with a complexing agent consisting exclusively of EDTA.

37. The cleaning process according to claim 21, which comprises carrying out the complexation stage in slightly acidic to slightly alkaline solution.

38. The cleaning process according to claim 37, which comprises maintaining a pH from substantially 6 to substantially 10 in the complexation stage.

39. The cleaning process according to claim 38, which comprises maintaining a pH from 6.5 to 9.3 in the complexation stage.
